(19) United States
(12) Patent Application Publication
(10) Pub. No.: US 2012/0290786 A1
(43) Pub. Date: Nov. 15, 2012

(54) SELECTIVE CACHING IN A STORAGE SYSTEM

(76) Inventor: Michael P. Mesnier, Scappoose, OR (US)

(21) Appl. No.: 13/105,333

(22) Filed: May 11, 2011

(51) Int. Cl. G06F 12/08

(52) U.S. Cl. 711/113; 711/118; 711/136; 711/E12.017; 711/E12.02

(57) ABSTRACT

A device, system, and method are disclosed. In one embodiment, a device includes caching logic that is capable of receiving an I/O storage request from an operating system. The I/O storage request includes an input/output (I/O) data type tag that specifies a type of I/O data to be stored or loaded with the I/O storage request. The caching logic is also capable of determining, based at least in part on a priority level associated with the I/O data type, whether to allocate cache to the I/O storage request.

### FIELD OF THE INVENTION

The invention relates to storage systems and, in particular, to selective caching in a storage system.

### RELATED APPLICATION

The present application is related to patent application Ser. No. 12/319,012, by Michael Mesnier and David Koufaty, filed on Dec. 31, 2008, entitled, “Providing Differentiated I/O Services within a Hardware Storage Controller,” which is herein incorporated by reference in its entirety.

### BACKGROUND OF THE INVENTION

Storage systems export a narrow I/O (input/output) interface, such as ATA (Advanced Technology Attachment) or SCSI (Small Computer Systems Interface), whose access to data consists primarily of two commands: READ and WRITE. This block-based interface abstracts storage from higher-level constructs, such as applications, processes, threads, and files. Although this allows operating systems and storage systems to evolve independently, achieving end-to-end application Quality of Service (QoS) can be a difficult task.

### BRIEF DESCRIPTION OF THE DRAWINGS

The present invention is illustrated by way of example and is not limited by the drawings, in which like references indicate similar elements, and in which:

FIG. 1 illustrates an embodiment of a computer system and device capable of selective caching of I/O storage requests, in accordance with one example embodiment of the invention,

FIG. 2 is a block diagram of an example storage controller, in accordance with one example embodiment of the invention,

FIG. 3 is a block diagram of an example I/O storage request, in accordance with one example embodiment of the invention,

FIG. 4 is a block diagram of an example cache listing, in accordance with one example embodiment of the invention,

FIG. 5 is a flow chart of an example method of selectively allocating cache entries, in accordance with one example embodiment of the invention,

FIG. 6 is a flow chart of an example method of selectively evicting cache entries, in accordance with one example embodiment of the invention, and

FIG. 7 is a block diagram of an example storage medium including content which, when accessed by a device, causes the device to implement one or more aspects of one or more embodiments of the invention.

### DETAILED DESCRIPTION OF THE INVENTION

Embodiments of a device, system, and method to provide selective caching in a storage system are disclosed.

In many embodiments, a QoS architecture for file and storage systems is described. The QoS architecture defines an operating system (OS) interface by which file systems can assign arbitrary policies (performance and/or reliability) to I/O streams, and it provides mechanisms that storage systems can use to enforce these policies. In many embodiments, the approach assumes that a stream identifier can be included in-band with each I/O request (e.g, using a field in the SCSI command set) and that the policy for each stream can be specified out-of-band through the management interface of the storage system.

Reference in the following description and claims to “one embodiment” or “an embodiment” of the disclosed techniques means that a particular feature, structure, or characteristic described in connection with the embodiment is included in at least one embodiment of the disclosed techniques. Thus, the appearances of the phrase “in one embodiment” appearing in various places throughout the specification are not necessarily all referring to the same embodiment.

In the following description and claims, the terms “include” and “comprise,” along with their derivatives, may be used, and are intended to be treated as synonyms for each other. In addition, in the following description and claims, the terms “coupled” and “connected,” along with their derivatives may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

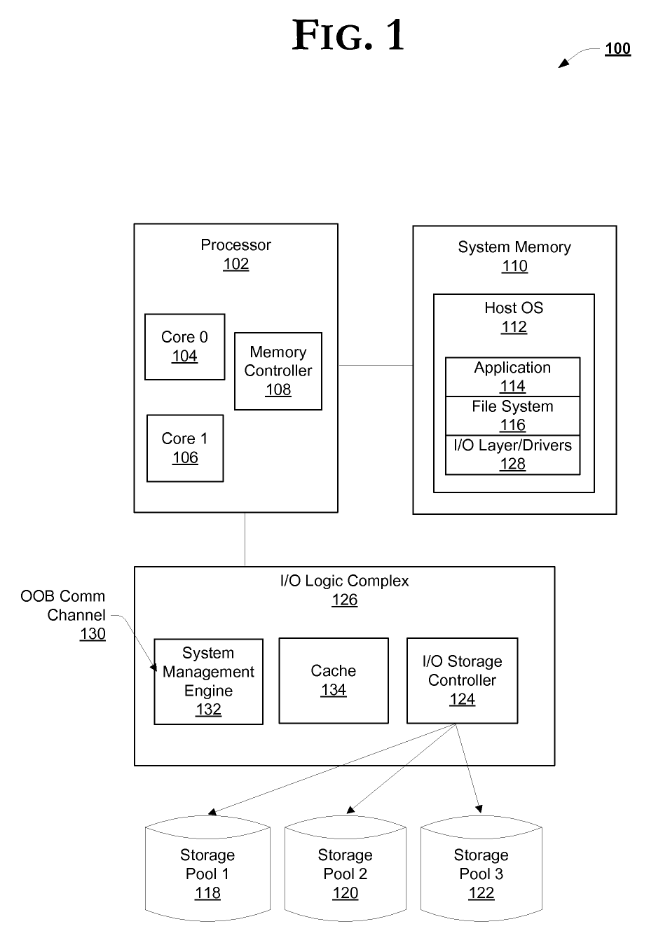

FIG. 1 illustrates an embodiment of a computer system and device capable of selective caching of I/O storage requests, in accordance with one example embodiment of the invention. The computer system 100 may include a processor, such as processor 102. In other embodiments that are not shown, the computer system 100 may include two or more processors. Processor 102 may be an Intel®-based central processing unit (CPU) or another brand CPU. In different embodiments, processor 102 may have one or more cores. For example, FIG. 1 shows processor 102 with two cores: core 0 (104) and core 1 (106).

Processor 102 is coupled to a memory subsystem through memory controller 108. Although FIG. 1 shows memory controller 108 integrated into processor 102, in other embodiments that are not shown, the memory controller may be integrated into a bridge device or other device in the computer system that is discrete from processor 102. The memory subsystem includes system memory 110 to store instructions to be executed by the processor. The memory devices in the memory subsystem may be any type of volatile dynamic random access memory (DRAM), for example double data rate (DDR) synchronous DRAM, and/or any type of non-volatile memory, for example a form of Flash memory. The processor(s) is coupled to the memory by a processor-memory interface, which may be a link (i.e. an interconnect/bus) that includes individual lines that can transmit data, address, control, and other information between the processor(s) and the memory.

The host operating system (OS) 112 is representative of an operating system that would be loaded into the memory of the computer system 100 while the system is operational to provide general operational control over the system and any peripherals attached to the system. The host OS 112 may be a form of Microsoft® Windows®, UNIX, LINUX, or any other OS. The host OS 112 provides an environment in which one or more programs, services, or agents can run within. In many embodiments, one or more applications, such as application 114, is running on top of the host OS 112. The application may be any type of software application that performs one or more tasks while utilizing system resources. A file system 116 runs in conjunction with the host OS 112 to provide the specific structure for how files are stored in one or more storage mediums accessible to the host OS 112. In many embodiments, the file system 116 organizes files stored in the storage mediums on fixed-size blocks. For example, if the host OS 112 wants to access a particular file, the file system 116 can locate the file and specify that the file is stored on a specific set of blocks. In different embodiments, the file system 116 may be Linux Ext2, Linux Ext3, Microsoft® Windows® NTFS, or any other file system.

The host OS 112 utilizes the file system 116 to provide information as to the particular blocks necessary to access a file. Once the file system 116 has provided this block information related to a particular file, the request to access the actual storage medium may be made through a driver 128 in an I/O layer of the host OS 112. The I/O layer includes code to process the access request to one or more blocks. In different embodiments, the driver may be implementing an I/O protocol such as a small computer system interface (SCSI) protocol, Internet SCSI protocol, Serial Advanced Technology Attachment (SATA) protocol, or another I/O protocol. The driver 128 processes the block request and sends the I/O storage request to a storage controller 124, which then proceeds to access a storage medium.

The storage mediums may be located within pools of storage, such as storage pools 118, 120, and 122. Storage mediums within the storage pools may include hard disk drives, large non-volatile memory banks, solid-state drives, tape drives, optical drives, and/or one or more additional types of storage mediums in different embodiments.

In many embodiments, a given storage pool may comprise a group of several individual storage devices of a single type. For example, storage pool 1 (118) may comprise a group of solid-state drives, storage pool 2 (120) may comprise a group of hard disk drives in a redundant array of independent disks (RAID) array, and storage pool 3 (122) may comprise a group of tape drives. In this example, storage pool 1 (118) may provide the highest storage quality of service because solid-state drives have better response times than standard hard disk drives or tape drives. Storage pool 2 (120) may provide a medium level of quality of service due to hard disk speed being slower than solid-state drive speed but faster than tape drive speed. Storage pool 3 (122) may provide a low level of quality of service due to the tape drive speed being the slowest of the three pools. In other embodiments, other types of storage mediums may be provided within one or more of the storage pools.

The host OS 112 or application 114 communicates with one or more of the storage mediums in the storage pools by having the driver 128 send the I/O storage request to the storage controller 124. The storage controller 124 provides a communication interface with the storage pools. In many embodiments, the storage controller 124 is aware of the level of service (i.e. performance) of each of the storage pools. Thus, from the example described above, the storage controller 124 is aware that storage pool 1 (118) provides a high level of service performance, storage pool 2 (120) provides a medium level of service performance, and storage pool 3 (122) provides a low level of service performance.

In some embodiments, the storage pools provide their respective quality of service information to the storage controller 124. In other embodiments, the storage controller actively stores a list that maps a certain quality of service to each storage pool. In yet other embodiments, the storage controller must identify each available storage pool and determine each pool's quality of service level. The storage controller 124 may include performance monitoring logic that may monitor the performance (e.g. latency) of transactions to each pool and track a dynamic quality of service metric for each storage pool. In still yet other embodiments, an external entity such as an administrator may provide an I/O storage request routing policy that specifies the quality of service levels expected to be provided by each storage pool and which data types should be routed to each pool. Additionally, the administrator may provide this information through an out-of-band communication channel 130 that may be updated through a system management engine 132 located in the computer system and coupled to the storage controller 124. The system management engine may be a separate integrated circuit that can assist remote entities, such as a corporate information technology department, perform management tasks related to the computer system.

The storage controller may be integrated into an I/O logic complex 126. The I/O logic complex 126 may include other integrated controllers for managing portions of the I/O subsystem within the local computer system 200. The I/O logic complex 126 may be coupled to the host processor 102 through an interconnect (e.g. a bus interface) in some embodiments. In other embodiments that are not shown, the storage controller 124 may be discrete from the computer system 200 and the I/O logic complex may communicate with the host processor 102 and system memory 110 through a network (such as a wired or wireless network).

In many embodiments, I/O tagging logic is implemented in the file system 116. The I/O tagging logic can specify the type, or class, of I/O issued with each I/O storage request. For example, an I/O storage request sent to the storage controller 124 may include file data, directory data, or metadata. Each of these types of data may benefit from differing levels of service. For example, the metadata may be the most important type of data, the directory data may be the next most important type of data, and the file data may be the least important type of data. These levels of importance are modifiable and may change based on implementation. The levels of importance may coincide directly with the quality of service utilized in servicing each type of data. Additionally, in other embodiments, other types of data may be issued with the I/O storage requests. In any event, in embodiments where metadata, directory data, and file data comprise the three types of data to be issued, the file system 116 may include a tag, or classification field, with each block request that specifies the type of data as one of the three types listed. To accomplish this, the block I/O layer (file system layer) of the host OS 112 may be modified to add an I/O data type tag field to each logical block request to a disk. Thus, the tag, or classifier, may be passed to the driver 128 in the block I/O layer.

The driver 128 in the I/O layer of the host OS 112 will then insert the I/O data type tag along with each I/O storage request sent to the storage controller 124. The specific disk request sent to the storage controller (i.e. a SCSI or ATA request) would include the I/O data type tag in a field. In some embodiments, the tag may be stored in reserved byte fields in the SCSI or ATA command structure (e.g. the SCSI block command includes reserved bits that may be utilized to store the tag as shown in FIG. 3). In other embodiments, the standards bodies for each I/O protocol may formally add the tag as a field in one or more standard commands sent from the driver 128 to the storage controller 124.

The storage controller 124 includes logic to monitor the I/O data type tag field in each I/O storage request. The storage controller 124 may include logic to route the I/O command to a specific storage pool based on the value stored in the tag. The storage controller can essentially provide differentiated storage services per I/O storage request based on the level of importance of the type of data issued with the request. Thus, if the data is of high importance, the data may be routed to the highest quality of service storage pool and if the data is of little importance, the data may be routed to the lowest quality of service storage pool.

The storage controller 124 also includes logic, as described in more detail hereinafter, to cache I/O requests in cache 134, based at least in part on the value stored in the tag. In one embodiment cache 134 is static random access memory (SRAM). In another embodiment cache 134 is a solid state drive (SSD). In one embodiment, storage controller 124 may cache all I/O requests when cache 134 is not under pressure (substantially dirty), and may selectively cache and evict I/O requests based on the data type tag when cache 134 is under pressure.

In some embodiments, the storage controller 124 is a RAID controller and the differentiated storage services based on I/O data type may be implemented as a new RAID level in the RAID storage system.

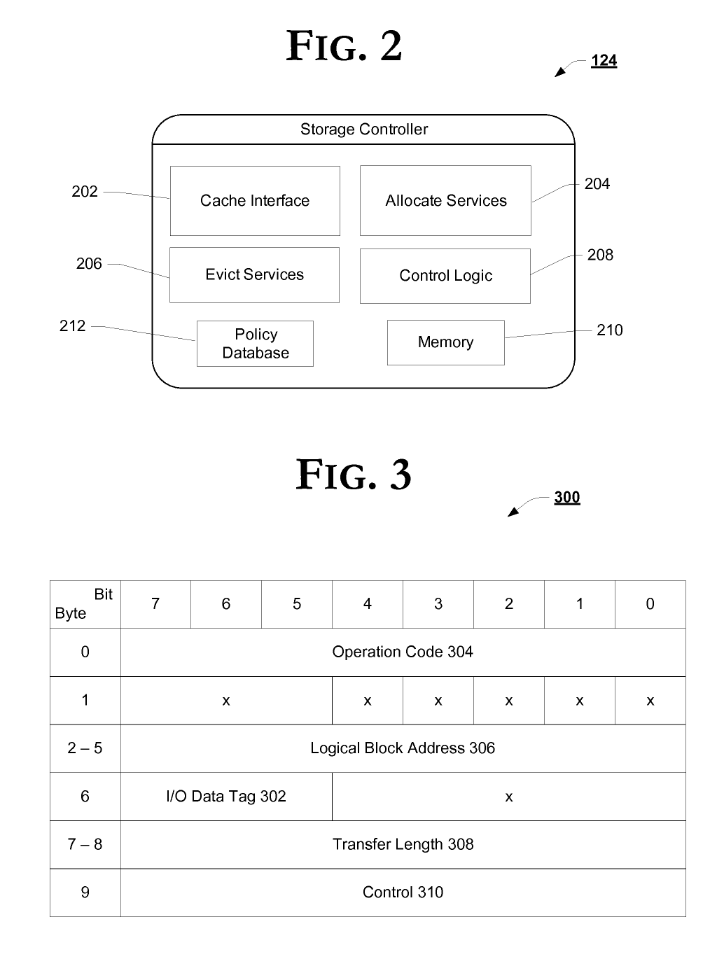

FIG. 2 is a block diagram of an example storage controller, in accordance with one example embodiment of the invention. In one embodiment, storage controller 124 may comprise cache interface 202, allocate services 204, evict services 206, control logic 208, memory 210, and policy database 212. Storage controller 124, and the functions described herein, may be implemented in hardware, software, or a combination of hardware and software.

Cache interface 202 may allow storage controller 124 to write to and read from cache 134.

Allocate services 204 may allow storage controller 124 to implement a method of selectively allocating cache entries, for example as described in reference to FIG. 5. In one embodiment, allocate services 204 may determine if an I/O request is worthy of a cache entry based at least in part on the indicated I/O data type. In one embodiment, allocate services 204 is enabled when cache pressure exists.

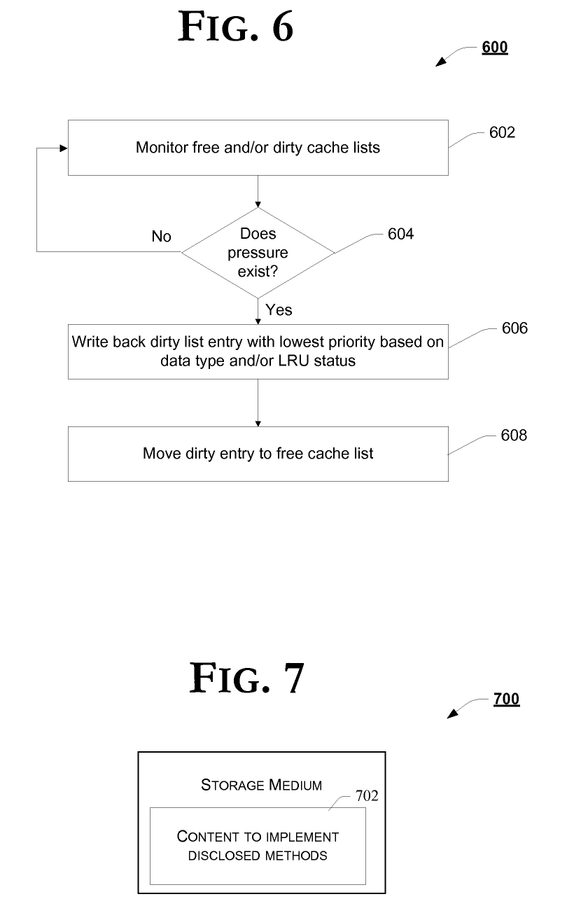

Evict services 206 may allow storage controller 124 to implement a method of selectively evicting cache entries, for example as described in reference to FIG. 6. In one embodiment, evict services 206 may write back dirty cache entries with lower priority, based at least in part on the indicated I/O data type, to free the cache space for higher priority entries. In one embodiment, evict services 206 represents a background process, such as a syncer daemon, that monitors cache pressure and that is enabled when cache pressure exists.

Control logic 208 may allow storage controller 124 to selectively invoke allocate services 204 and/or evict services 206, for example in response to receiving an I/O request. Control logic 208 may represent any type of microprocessor, controller, ASIC, state machine, etc.

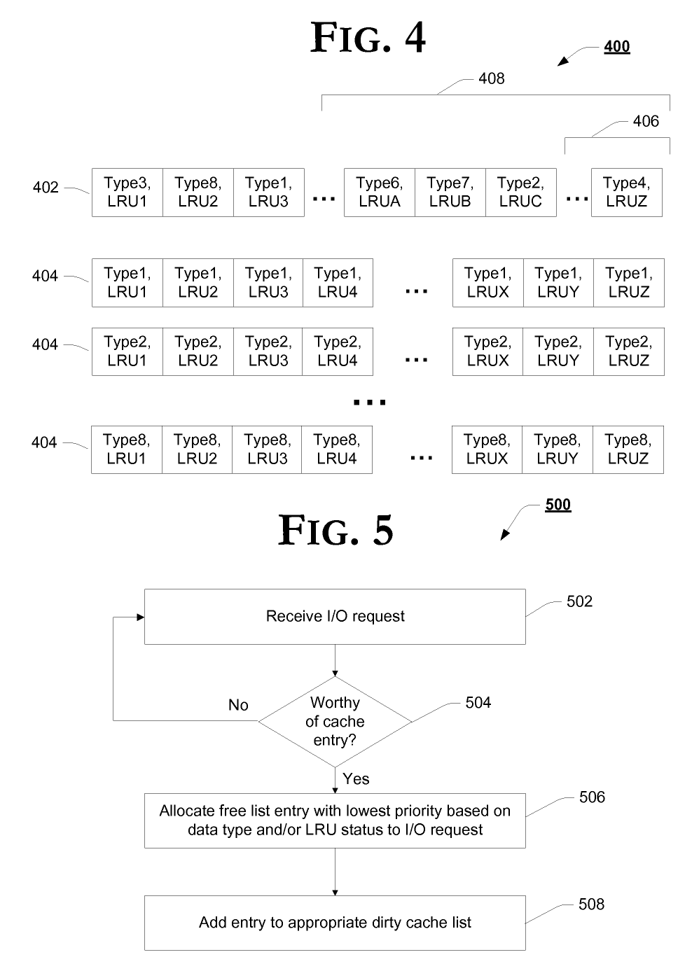

In one embodiment, memory 210 is present to store (either for a short-term or a long-term) free and dirty cache lists, for example as described in reference to FIG. 4.

Policy database 212 may contain records of quality of service policies for each class of data. In one embodiment, policy database 212 may be received through OOB communication channel 130.

FIG. 3 is a block diagram of an example I/O storage request, in accordance with one example embodiment of the invention. I/O request 300 may include I/O data tag 302, operation code 304, logical block address 306, transfer length 308, and control 310. Other fields may be included that aren't shown. In one embodiment, I/O request 300 represents a SCSI block command. In another embodiment I/O request 300 represents a command header. In one embodiment, I/O data tag 302 occupies bits listed as reserved in an appropriate specification. In another embodiment, I/O data tag 302 occupies bits listed as vendor specific, such as a group number, for example. While shown as occupying three bits, I/O data tag 302 may occupy more or fewer bits to indicate potential data types. In one embodiment, I/O data tag 302 can have one of eight values representing eight distinct data types, which may have eight distinct priority levels. In one embodiment, I/O data tag 302 is represented by the following table:

| Value | 000 | 001 | 010 | 011 | 100 | 101 | 110 | 111 |
|---|---|---|---|---|---|---|---|---|
| Priority | 1 | 2 | 3 | 4 | 5 | 6 | 7 | 8 |
| Type | Metadata | Journal | Directory | X-Small | Small | Medium | Large | Bulk |
| | | Entry | Entry | File | File | File | File | File |

In one embodiment, more or fewer data tag values may be possible with more or fewer bits allocated to I/O data tag 302. For example, 5 bits may be used for I/O data tag 302 providing up to 32 distinct values. In one embodiment, multiple data types may share a same priority level for quality of service purposes. In this way, the quality of service may be modified for some or all data types through changes of policy, communicated through a management interface, for example, independent of I/O data tag 302.

FIG. 4 is a block diagram of an example cache listing, in accordance with one example embodiment of the invention. Cache listing 400 may include free cache list 402 and dirty cache lists 404, which may be ordered based on least recently used status. Free cache list 402 may list entries that may be overwritten by a received I/O request. In one embodiment, the next free cache list 402 entry to be overwritten would be the least recently used entry (the right most entry in this example). While shown as being ordering by least recently used status, other ordering methods based, for example, on data type may be utilized without deviating from the scope of the present invention. Entries in cache listing 400 may include address, translation, or other information (not shown).

In one embodiment, storage controller 124 may monitor cache 134 to determine if cache pressure exists. In one embodiment, cache pressure exists when free cache list 402 is reduced to low watermark 406 number of entries and lasts until free cache list 402 is restored to high watermark 408 number of entries. Other techniques to define cache pressure may be utilized without deviating from the scope of the present invention.

Dirty cache lists 404 may comprise separate lists for cache entries of varying data types, as shown. In other embodiments, however, there may be less than one dirty cache list 404 per class, and data type may be utilized to prioritize entries.

FIG. 5 is a flow chart of an example method of selectively allocating cache entries, in accordance with one example embodiment of the invention. The process is performed by processing logic that may comprise hardware, software, or a combination of both. The process begins with control logic 208 receiving an I/O storage request with an I/O data type tag (processing block 502). I/O data type tag 302 may specify a type of data issued with the I/O storage request. In different embodiments, the type of data may be metadata, directory data, or file data of varying sizes.

Next, allocate services 204 utilizes the I/O data type tag to determine whether the I/O storage request is worthy of cache allocation (processing block 504). In one embodiment, allocate services 204 will only decide to allocate cache to an I/O request of at least as high of priority as the lowest priority dirty cache list 404 entry. For example, in one embodiment, allocate services 204 may only allocate cache to I/O requests of priority type 3 or higher. In another embodiment, allocate services 204 may cache every I/O request unless cache pressure exists.

The process continues for I/O requests worthy of cache entry with allocate services 204 allocating an entry of free cache list 402 (processing block 506) and adding the entry to the appropriate dirty cache list 404 (processing block 508). In one embodiment, allocate services 204 allocates the least recently used entry within free cache list 402. In one embodiment, allocate services 204 adds the entry to the associated dirty cache list 404 ahead of other entries of the same data type.

FIG. 6 is a flow chart of an example method of selectively evicting cache entries, in accordance with one example embodiment of the invention. The process is performed by processing logic that may comprise hardware, software, or a combination of both. The process begins with control logic 208 monitoring free cache list 402 and/or dirty cache list 404 (processing block 602).

Next, cache logic 208 determines whether cache pressure exists (processing block 604). In one embodiment, cache pressure exists when free cache list 402 is reduced to low watermark 406 number of entries and lasts until free cache list 402 is restored to high watermark 408 number of entries.

The process continues if cache pressure exists with evict services 206 writing back an entry of dirty cache list 404 (processing block 606) and adding the entry to the appropriate position in free cache list 402 (processing block 608). In one embodiment, evict services 206 writes back the least recently used entry of the lowest priority data type dirty cache list 404. In one embodiment, evict services 206 adds the entry to free cache list 402 ahead of other least recently used entries, but behind more recently used entries.

Evict services 206 may write back all cache entries of one (the lowest) priority level and then write back entries of another (the next lowest) priority level, and so on, until cache pressure no longer exists.

FIG. 7 is a block diagram of an example storage medium including content which, when accessed by a device, causes the device to implement one or more aspects of one or more embodiments of the invention. In this regard, storage medium 700 includes content 702 (e.g., instructions, data, or any combination thereof) which, when executed, causes the system to implement one or more aspects of methods described above.

The machine-readable (storage) medium 700 may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, the present invention may also be downloaded as a computer program product, wherein the program may be transferred from a remote computer to a requesting computer by way of data signals embodied in a carrier wave or other propagation medium via a communication link (e.g., a modem, radio or network connection).

Thus, embodiments of a device, system, and method to provide selective caching of I/O storage requests are disclosed. These embodiments have been described with reference to specific exemplary embodiments thereof. It will be evident to persons having the benefit of this disclosure that various modifications and changes may be made to these embodiments without departing from the broader spirit and scope of the embodiments described herein. The specification and drawings are, accordingly, to be regarded in an illustrative rather than a restrictive sense.

What is claimed is:

1. A storage system, comprising:
caching logic to
receive an I/O storage request from an operating system, the I/O storage request including an input/output (I/O) data type tag specifying a type of I/O data to be stored or loaded with the I/O storage request; and
determine, based at least in part on a priority level associated with the I/O data type, whether to allocate cache to the I/O storage request.

2. The storage system of claim 1, wherein the caching logic is further operable to:
identify the I/O data type tag within a command header.

3. The storage system of claim 1, wherein the caching logic is further operable to:
identify the I/O data type tag within a SCSI block command.

4. The storage system of claim 1, wherein the priority level comprises one of eight values.

5. The storage system of claim 1, wherein the I/O data type comprises one of eight types.

6. The storage system of claim 1, wherein the caching logic is further operable to:
maintain free and dirty cache lists ordered based on priority level and least recently used (LRU) status.

7. The storage system of claim 6, wherein the caching logic is further operable to:
evict a dirty cache list entry, based at least in part on the priority level, when cache pressure exists.

8. The storage system of claim 7, wherein cache pressure exists when the free cache list reaches a low watermark number of entries and until the free cache list reaches a high watermark number of entries.

9. A system, comprising:
a file system stored in a memory, the file system to provide an input/output (I/O) data type tag specifying a type of I/O data to store or load with an I/O storage request;
an operating system stored in the memory, the operating system to send the I/O storage request to a storage controller, the I/O storage request including the I/O data type tag as a field in the I/O storage request; and
the storage controller to:
receive the I/O storage request from the operating system;
determine, based at least in part on the I/O data type tag, whether to allocate cache to the I/O storage request.

10. The system of claim 9, wherein the storage controller is further operable to:
identify the I/O data type tag within a SCSI block command.

11. The system of claim 9, wherein the I/O data type tag comprises three bits.

12. The system of claim 9, wherein the storage controller comprises a redundant array of independent disks (RAID) controller.

13. The system of claim 9, further comprising solid state drive (SSD) cache memory.

14. The system of claim 9, wherein the storage controller is further operable to:
maintain free and dirty cache lists ordered based on I/O data type and least recently used (LRU) status.

15. The system of claim 14, wherein the storage controller is further operable to:
evict a dirty cache list entry, based at least in part on the I/O data type, when cache pressure exists.

16. The system of claim 15, wherein cache pressure exists when the free cache list reaches a low watermark number of entries and until the free cache list reaches a high watermark number of entries.

17. A method, comprising:
receiving an input/output (I/O) storage request, the I/O storage request including a tag specifying a type of I/O data to store or load;
determining, based at least in part on the I/O data type, whether to allocate cache to the I/O storage request.

18. The method of claim 17, further comprising:
maintaining free and dirty cache lists ordered based on I/O data type and least recently used (LRU) status.

19. The method of claim 18, further comprising:
evicting a dirty cache list entry, based at least in part on the I/O data type, when cache pressure exists.

20. The method of claim 19, wherein cache pressure exists when the free cache list reaches a low watermark number of entries and until the free cache list reaches a high watermark number of entries.
